(19) United States
(12) Patent Application Publication
(10) Pub. No.: US 2026/0300189 A1
(43) Pub. Date: Oct. 1, 2026

(54) KVM Switch System Capable of Ensuring Successful System Booting

(71) Applicant: BENQ CORPORATION, Taipei City (TW)

(72) Inventor: Chia-Ching Tsai, Taipei City (TW)

(73) Assignee: BENQ CORPORATION, Taipei City (TW)

(21) Appl. No.: 19/312,254

(22) Filed: Aug. 27, 2025

(30) Foreign Application Priority Data
Mar. 26, 2025 (TW) 114111440

(51) Int. Cl. G06F 13/10

(52) U.S. Cl. CPC G06F 13/102

(57) ABSTRACT

A KVM (Keyboard, Video, Mouse) switch system includes a first single-pole double-throw switch, a SoC (System on Chip) and a second double-pole double-throw switch. The first single-pole double-throw switch includes an input end coupled to a keyboard, a mouse and a monitor; a first output end; and a second output end. The SoC includes a first end coupled to the second output end of the first single-pole double-throw switch, and a second end. The second double-pole double-throw switch includes a first input end coupled to a first output end of the first single-pole double-throw switch, a second input end coupled to the second end of the SoC, a first output end coupled to a first host, and a second output end coupled to a second host.

### BACKGROUND OF THE INVENTION

### 1. Field of the Invention

The present invention relates to a KVM (Keyboard, Video, Mouse) switch system, and more particularly to a KVM switch system which ensures successful system booting by utilizing a predetermined switching path.

### 2. Description of the Prior Art

A KVM (Keyboard, Video, Mouse) switch system, also known as a multi-computer switch system, is a type of computer hardware device that enables a user to control a plurality of computers using a single keyboard, monitor, and mouse. When the plurality of computers are coupled to a KVM switch system, the user can control one of the connected computers and switch control to another computer via keyboard hotkeys or a physical switch on the KVM device. More advanced KVM switch systems also support the sharing of additional peripherals such as Universal Serial Bus (USB) devices and audio equipment.

The user connects a monitor, keyboard, and mouse to the KVM switch system, and then uses specialized cables (typically USB, Video Graphics Array (VGA), or High Definition Multimedia Interface (HDMI) cables) to connect the KVM switch system to the plurality of computer hosts. By operating the switch on the KVM device or using designated keyboard hotkeys, the user can switch control from the currently active computer to another selected computer. Most electronic devices connected to the KVM switch system can be controlled via keyboard commands, commonly referred to as “hotkeys,” which vary depending on the specific KVM switch system.

However, when the firmware of the KVM switch system requires an Over-the-Air (OTA) update, or when the system encounters a failure that prevents it from booting, the monitor, keyboard, and mouse connected to the KVM switch system become inoperable. Therefore, there is a need for a KVM switch system that ensures successful booting by utilizing a predetermined switching path.

### SUMMARY OF THE INVENTION

An embodiment provides a KVM (Keyboard, Video, Mouse) switch system. The KVM switch system includes a first Single Pole Double Throw (SPDT) switch, a System on Chip (SoC), and a second Double Pole Double Throw (DPDT) switch. The first SPDT switch includes an input end coupled to a keyboard, a mouse, and a monitor; a first output end; and a second output end. The SoC includes a first end coupled to the second output end of the first SPDT switch, and a second end. The second DPDT switch includes a first input end coupled to the first output end of the first SPDT switch, a second input end coupled to the second end of the SoC, a first output end coupled to a first host, and a second output end coupled to a second host. When the KVM switch system is in a default mode, the first SPDT switch is preset to enable its first output end, and the second DPDT switch is preset to enable its first input end and its first output end, thereby enabling the KVM switch system to default to using the first host.

Another embodiment provides a KVM switch system. The KVM switch system includes a first SPDT switch, a System on Chip (SoC), a second Single Pole N Throw (SPNT) switch, and a third SPDT switch. The first SPDT switch includes an input end coupled to a keyboard, a mouse, and a monitor; a first output end; and a second output end. The SoC includes a first end coupled to the second output end of the first SPDT switch, and a second end. The second SPNT switch includes an input end coupled to the second end of the SoC, a first output end, and an nth output end coupled to an nth host. The third SPDT switch includes a first input end coupled to the first output end of the first SPDT switch, a second input end coupled to the first output end of the second SPNT switch, and an output end coupled to a first host. When the KVM switch system is in a default mode, the first SPDT switch is preset to enable its first output end, and the third SPDT switch is preset to enable its first input end, thereby enabling the KVM switch system to default to using the first host, where N≥n>1.

Another embodiment provides a KVM switch system. The KVM switch system includes a first SPDT switch, a System on Chip (SoC), a second SPNT switch, a third SPNT switch, a fourth SPDT switch, and a fifth-nth SPDT switch. The first SPDT switch includes an input end coupled to a keyboard, a mouse, and a monitor; a first output end; and a second output end. The SoC includes a first end coupled to the second output end of the first SPDT switch, and a second end. The second SPNT switch includes an input end coupled to the first output end of the first SPDT switch, a first output end, and an nth output end. The third SPNT switch includes an input end coupled to the second end of the SoC, a first output end, and an nth output end. The fourth SPDT switch includes a first input end coupled to the first output end of the second SPNT switch, a second input end coupled to the first output end of the third SPNT switch, and an output end coupled to a first host. The fifth-nth SPDT switch includes a first input end coupled to the nth output end of the second SPNT switch, a second input end coupled to the nth output end of the third SPNT switch, and an output end coupled to an nth host. When the KVM switch system is in a default mode, the first SPDT switch is preset to enable its first output end, the fourth SPDT switch is preset to enable its first input end, and the fifth-nth SPDT switch is preset to enable its first input end, thereby enabling the KVM switch system to default to using either the first host or the nth host, where N≥n>1.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a KVM (Keyboard,

Video, Mouse) switch system according to an embodiment of the present invention.

FIG. 2 is a block diagram illustrating a KVM switch system according to another embodiment of the present invention.

FIG. 3 is a block diagram illustrating a KVM switch system according to another embodiment of the present invention.

FIG. 4 is a block diagram illustrating a KVM switch system according to another embodiment of the present invention.

FIG. 5 is a block diagram illustrating a KVM switch system according to another embodiment of the present invention.

FIG. 6 is a block diagram illustrating a KVM switch system according to another embodiment of the present invention.

FIG. 7 is a block diagram illustrating a KVM switch system according to another embodiment of the present invention.

### DETAILED DESCRIPTION

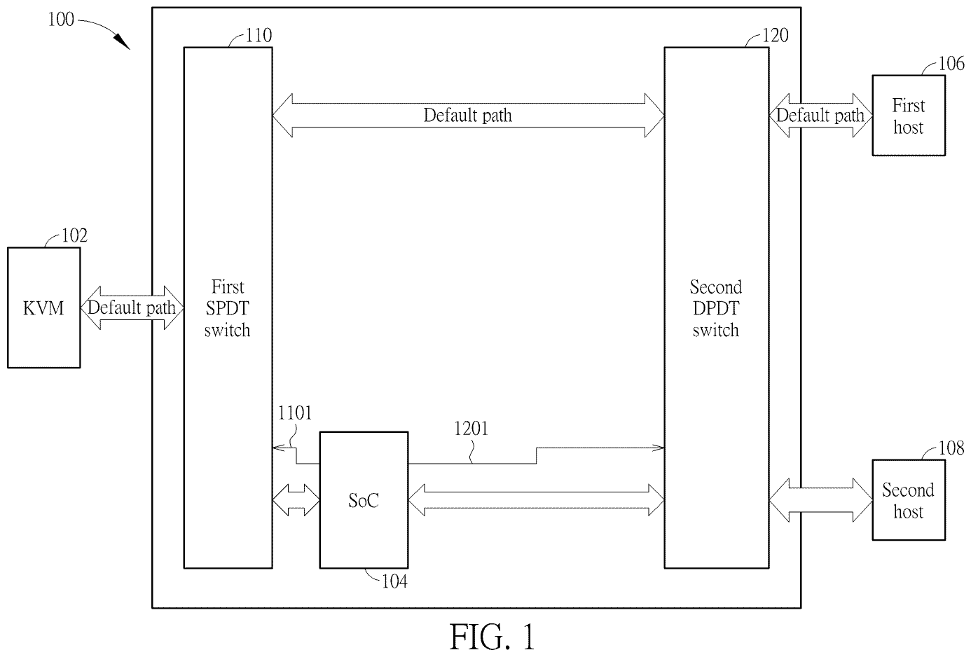

FIG. 1 is a block diagram illustrating a KVM (Keyboard, Video, Mouse) switch system 100 according to an embodiment of the present invention. The KVM switch system 100 includes a first Single Pole Double Throw (SPDT) switch 110, a System on Chip (SoC) 104, and a second Double Pole Double Throw (DPDT) switch 120. The first SPDT switch 110 includes an input end coupled to a keyboard, mouse, and monitor 102; a first output end; and a second output end. The SoC 104 includes a first end coupled to the second output end of the first SPDT switch 110, and a second end. The second DPDT switch 120 includes a first input end coupled to the first output end of the first SPDT switch 110, a second input end coupled to the second end of the SoC 104, a first output end coupled to a first host 106, and a second output end coupled to a second host 108.

When the SoC 104 is undergoing firmware updates or fails to boot, the KVM switch system 100 automatically enters default mode. In default mode, the first SPDT switch 110 is preset to enable its first output end, and the second DPDT switch 120 is preset to enable its first input end and its first output end, thereby enabling the system to default to using the first host 106. The signal path in default mode is as follows: the keyboard, mouse, and monitor 102 transmit or receive signals through the first SPDT switch 110, which connects to the second DPDT switch 120, and then to the first host 106.

When the KVM switch system 100 intends to toggle the SoC 104 to control the first host 106, the SoC 104 generates a first SPDT switch control signal 1101 to toggle the first SPDT switch 110 to its second output end, and a second DPDT switch control signal 1201 to toggle the second DPDT switch 120 to its second input end and its first output end. This allows the KVM switch system 100 to control the first host 106 via the SoC 104. Similarly, to switch to the second host 108, the SoC 104 generates control signals to toggle the first SPDT switch 110 to its second output end, and the second DPDT switch 120 to its second input end and its second output end.

In one embodiment, the first SPDT switch 110 in the KVM switch system 100 is coupled to the monitor 102 via a High Definition Multimedia Interface (HDMI), and to the keyboard and mouse 102 via Universal Serial Bus (USB). In one embodiment, the first host 106 and second host 108 are personal computers.

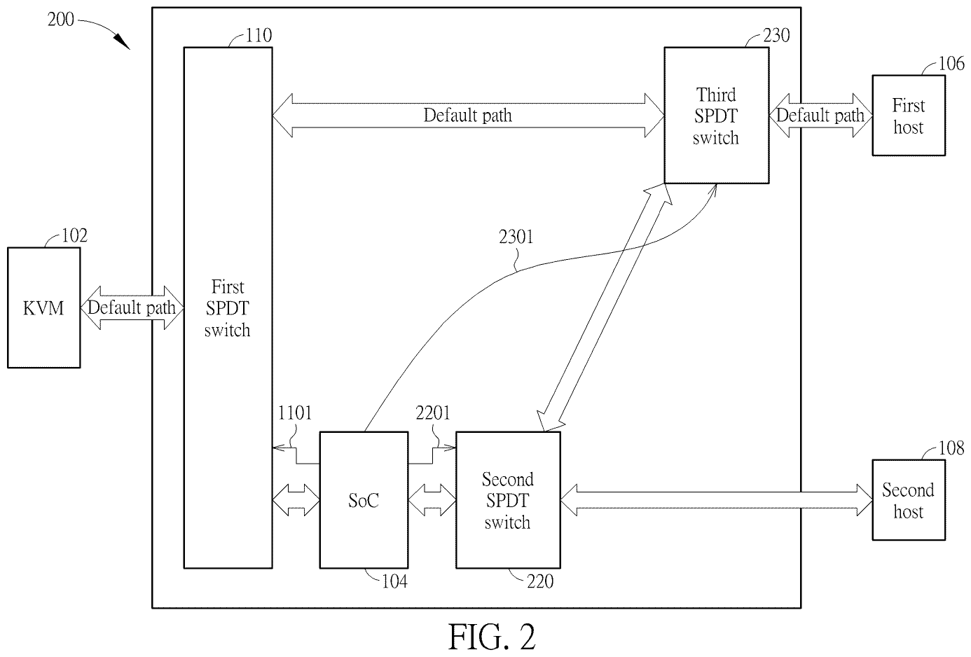

FIG. 2 is a block diagram illustrating a KVM switch system 200 according to another embodiment of the present invention. The KVM switch system 200 includes a first SPDT switch 110, a SoC 104, a second SPDT switch 220, and a third SPDT switch 230. The first Single Pole Double Throw (SPDT) switch 110 includes an input end coupled to a keyboard, mouse, and monitor 102; a first output end; and a second output end. The System on Chip (SoC) 104 includes a first end coupled to the second output end of the first SPDT switch 110, and a second end. The second SPDT switch 220 includes an input end coupled to the second end of the SoC 104, a first output end, and a second output end coupled to a second host 108. The third SPDT switch 230 includes a first input end coupled to the first output end of the first SPDT switch 110, a second input end coupled to the first output end of the second SPDT switch 220, and an output end coupled to a first host 106.

When the SoC 104 is updating firmware or fails to boot, the KVM switch system 200 automatically enters default mode. In this mode, the first SPDT switch 110 is preset to enable its first output end, and the third SPDT switch 230 is preset to enable its first input end, enabling default control of the first host 106. The signal path in default mode is as follows: the keyboard, mouse, and monitor 102 transmit or receive signals through the first SPDT switch 110, which connects to the third SPDT switch 230, and then to the first host 106.

When the KVM switch system 200 intends to toggle the System on Chip (SoC) 104 to control the first host 106, the SoC 104 generates a first SPDT switch control signal 1101 to toggle the first SPDT switch 110 to its second output end, a second SPDT switch control signal 2201 to toggle the second SPDT switch 220 to its first output end, and a third SPDT switch control signal 2301 to toggle the third SPDT switch 230 to its second input end. In this manner, the KVM switch system 200 can control the first host 106 via the SoC 104. When the KVM switch system 200 intends to toggle the SoC 104 to control the second host 108, the SoC 104 generates the first SPDT switch control signal 1101 to toggle the first SPDT switch 110 to its second output end, and the second SPDT switch control signal 2201 to toggle the second SPDT switch 220 to its second output end. In this manner, the KVM switch system 200 can control the second host 108 via the SoC 104.

In one embodiment, the first SPDT switch 110 in the KVM switch system 200 is connected via High Definition Multimedia Interface (HDMI) to the monitor 102 and via Universal Serial Bus (USB) to the keyboard and mouse 102. In an embodiment, the first host 106 and second host 108 are personal computers.

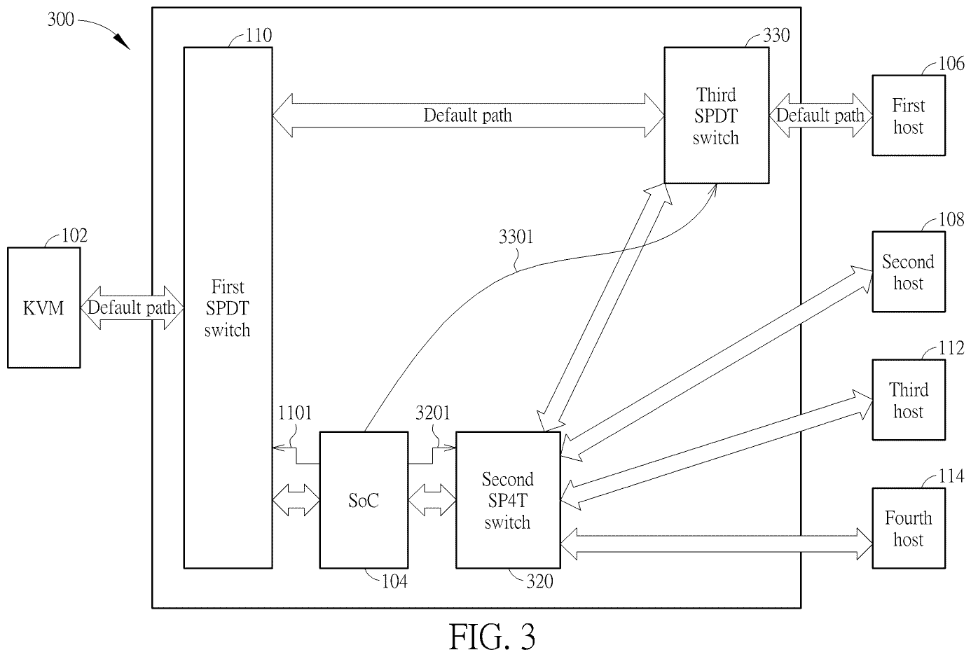

FIG. 3 is a block diagram illustrating a KVM switch system 300 according to another embodiment of the present invention. The KVM switch system 300 includes a first Single Pole Double Throw (SPDT) switch 110, a System on Chip (SoC) 104, a second Single Pole Four Throw (SP4T) switch 320, and a third SPDT switch 330. The first SPDT switch 110 includes an input end coupled to a keyboard, mouse, and monitor 102; a first output end; and a second output end. The SoC 104 includes a first end coupled to the second output end of the first SPDT switch 110, and a second end. The second SP4T switch 320 includes an input end coupled to the second end of the SoC 104, a first output end, a second output end coupled to a second host 108, a third output end coupled to a third host 112, and a fourth output end coupled to a fourth host 114. The third SPDT switch 330 includes a first input end coupled to the first output end of the first SPDT switch 110, a second input end coupled to the first output end of the second SP4T switch 320, and an output end coupled to a first host 106.

When the System on Chip (SoC) 104 is undergoing firmware updates or fails to boot, the KVM switch system 300 automatically enters default mode. In default mode, the first Single Pole Double Throw (SPDT) switch 110 is preset to enable its first output end, and the third SPDT switch 330 is preset to enable its first input end, thereby enabling the KVM switch system 300 to default to using the first host 106. The default signal path in default mode is as follows: the keyboard, mouse, and monitor 102 transmit or receive signals through the first SPDT switch 110, which connects to the third SPDT switch 330, and then to the first host 106.

When the KVM switch system 300 intends to toggle the System on Chip (SoC) 104 to control the first host 106, the SoC 104 generates a first SPDT switch control signal 1101 to toggle the first SPDT switch 110 to its second output end, a second Single Pole Four Throw (SP4T) switch control signal 3201 to toggle the second SP4T switch 320 to its first output end, and a third SPDT switch control signal 3301 to toggle the third SPDT switch 330 to its second input end. In this manner, the KVM switch system 300 can control the first host 106 via the SoC 104. When the KVM switch system 300 intends to toggle the SoC 104 to control the second host 108, the SoC 104 generates the first SPDT switch control signal 1101 to toggle the first SPDT switch 110 to its second output end, and the second SP4T switch control signal 3201 to toggle the second SP4T switch 320 to its second output end. In this manner, the KVM switch system 300 can control the second host 108 via the SoC 104. When the KVM switch system 300 intends to switch the SoC 104 to control the third host 112, the SoC 104 generates the first SPDT switch control signal 1101 to toggle the first SPDT switch 110 to its second output end, and the second SP4T switch control signal 3201 to toggle the second SP4T switch 320 to its third output end. In this manner, the KVM switch system 300 can control the third host 112 via the SoC 104. When the KVM switch system 300 intends to toggle the SoC 104 to control the fourth host 114, the SoC 104 generates the first SPDT switch control signal 1101 to toggle the first SPDT switch 110 to its second output end, and the second SP4T switch control signal 3201 to toggle the second SP4T switch 320 to its fourth output end. In this manner, the KVM switch system 300 can control the fourth host 114 via the SoC 104.

In one embodiment, the first SPDT switch 110 in the KVM switch system 300 is connected via HDMI to the monitor 102 and via USB to the keyboard and mouse 102. In an embodiment, the first host 106, the second host 108, the third host 112, and the fourth host 114 are personal computers.

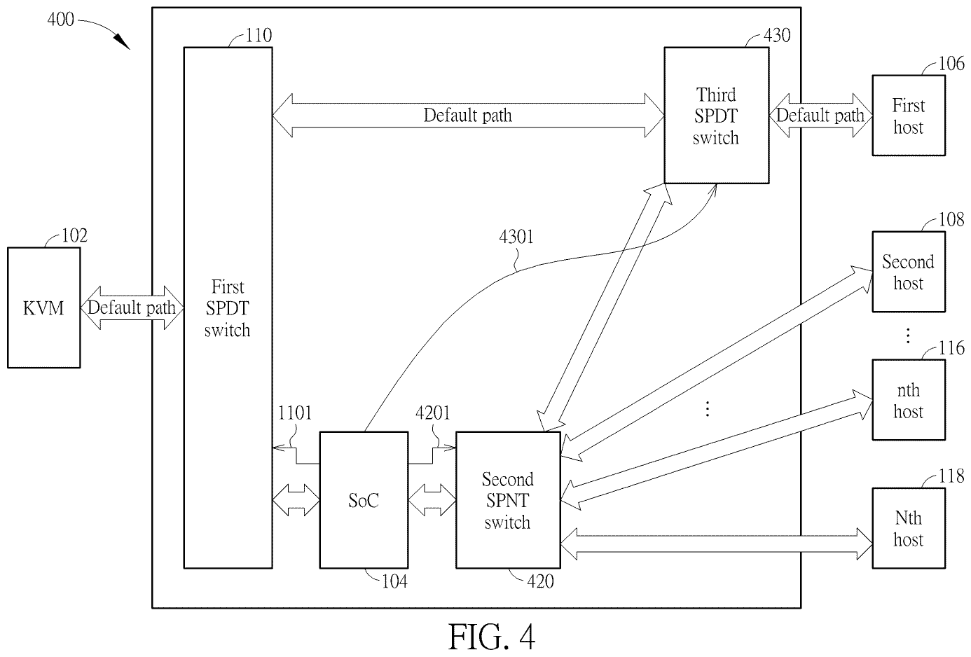

FIG. 4 is a block diagram illustrating a KVM switch system 400 according to another embodiment of the present invention. The KVM switch system 400 includes a first Single Pole Double Throw (SPDT) switch 110, a System on Chip (SoC) 104, a second Single Pole N Throw (SPNT) switch 420, and a third SPDT switch 430. The first SPDT switch 110 includes an input end coupled to a keyboard, mouse, and monitor 102; a first output end; and a second output end. The SoC 104 includes a first end coupled to the second output end of the first SPDT switch 110, and a second end. The second SPNT switch 420 includes an input end coupled to the second end of the SoC 104, a first output end, and an nth output end coupled to an nth host 116. The third SPDT switch 430 includes a first input end coupled to the first output end of the first SPDT switch 110, a second input end coupled to the first output end of the second SPNT switch 420, and an output end coupled to a first host 106.

When the System on Chip (SoC) 104 is undergoing firmware updates or fails to boot, the KVM switch system 400 automatically enters default mode. In default mode, the first Single Pole Double Throw (SPDT) switch 110 is preset to enable its first output end, and the third SPDT switch 430 is preset to enable its first input end, thereby enabling the KVM switch system 400 to default to using the first host 106. In one embodiment, N≥n>1, and both N and n are positive integers. The signal path in default mode is as follows: the keyboard, mouse, and monitor 102 transmit or receive signals through the first SPDT switch 110, which connects to the third SPDT switch 430, and then to the first host 106.

When the KVM switch system 400 intends to toggle the System on Chip (SoC) 104 to control the first host 106, the SoC 104 generates a first SPDT switch control signal 1101 to toggle the first SPDT switch 110 to its second output end, a second Single Pole N Throw (SPNT) switch control signal 4201 to toggle the second SPNT switch 420 to its first output end, and a third SPDT switch control signal 4301 to toggle the third SPDT switch 430 to its second input end. In this manner, the KVM switch system 400 can control the first host 106 via the SoC 104. When the KVM switch system 400 intends to toggle the SoC 104 to control the nth host 116, the SoC 104 generates the first SPDT switch control signal 1101 to toggle the first SPDT switch 110 to its second output end, and the second SPNT switch control signal 4201 to toggle the second SPNT switch 420 to its nth output end. In this manner, the KVM switch system 400 can control the nth host 116 via the SoC 104.

In one embodiment, the first Single Pole Double Throw (SPDT) switch 110 in the KVM switch system 400 is coupled to the monitor 102 via a High Definition Multimedia Interface (HDMI), and to the keyboard and mouse 102 via a Universal Serial Bus (USB). In one embodiment, the first host 106, second host 108, nth host 116, and Nth host 118 are personal computers.

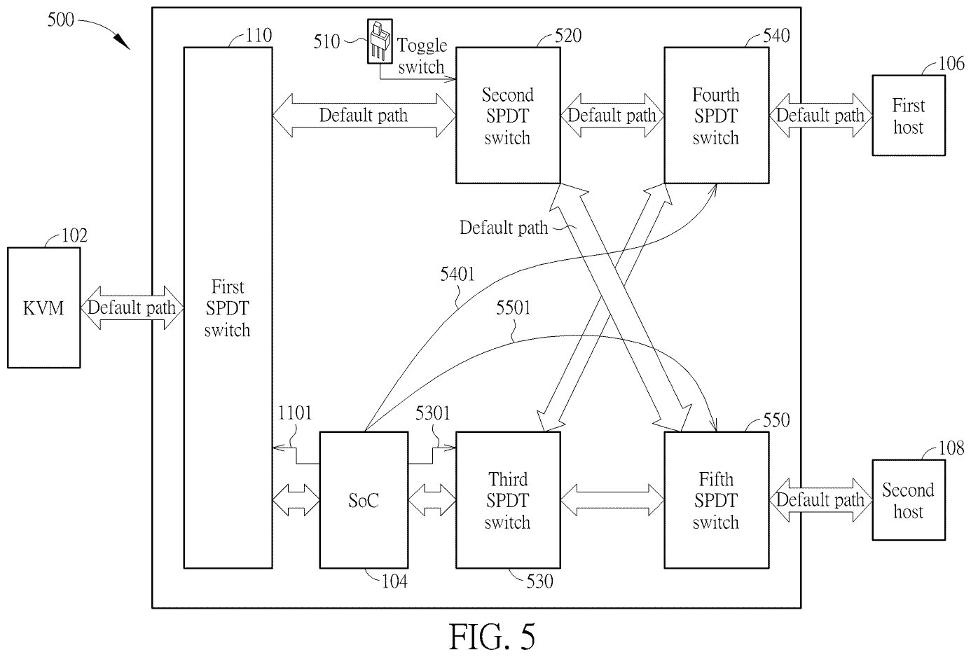

FIG. 5 is a block diagram illustrating a KVM switch system 500 according to another embodiment of the present invention. The KVM switch system 500 includes a first Single Pole Double Throw (SPDT) switch 110, a System on Chip (SoC) 104, a toggle switch 510, a second SPDT switch 520, a third SPDT switch 530, a fourth SPDT switch 540, and a fifth SPDT switch 550. The first SPDT switch 110 includes an input end coupled to a keyboard, mouse, and monitor 102; a first output end; and a second output end. The SoC 104 includes a first end coupled to the second output end of the first SPDT switch 110, and a second end. The toggle switch 510 is coupled to the second SPDT switch 520 for manually switching the output path of the second SPDT switch 520 when in default mode. The second SPDT switch 520 includes an input end coupled to the first output end of the first SPDT switch 110, a first output end, and a second output end. The third SPDT switch 530 includes an input end coupled to the second end of the SoC 104, a first output end, and a second output end. The fourth SPDT switch 540 includes a first input end coupled to the first output end of the second SPDT switch 520, a second input end coupled to the first output end of the third SPDT switch 530, and an output end coupled to a first host 106. The fifth SPDT switch 550 includes a first input end coupled to the second output end of the second SPDT switch 520, a second input end coupled to the second output end of the third SPDT switch 530, and an output end coupled to a second host 108.

When the System on Chip (SoC) 104 is undergoing firmware updates or fails to boot, the KVM switch system 500 automatically enters default mode. In default mode, the first Single Pole Double Throw (SPDT) switch 110 is preset to enable its first output end, the fourth SPDT switch 540 is preset to enable its first input end, and the fifth SPDT switch 550 is preset to enable its first input end. The toggle switch 510 allows manual switching of the second SPDT switch 520 to either its first output end or its second output end, thereby enabling the KVM switch system 500 to default to using either the first host 106 or the second host 108. The signal path in default mode for switching to the first host 106 is as follows: the keyboard, mouse, and monitor 102 transmit or receive signals through the first SPDT switch 110, then pass through the second SPDT switch 520, followed by the fourth SPDT switch 540—which is controlled by the toggle switch 510—and finally reach the first host 106. The default signal path for switching to the second host 108 is as follows: the keyboard, mouse, and monitor 102 transmit or receive signals through the first SPDT switch 110, then pass through the second SPDT switch 520, followed by the fifth SPDT switch 550—which is controlled by the toggle switch 510—and finally reach the second host 108.

When the KVM switch system 500 intends to toggle the System on Chip (SoC) 104 to control the first host 106, the SoC 104 generates a first SPDT switch control signal 1101 to toggle the first SPDT switch 110 to its second output end, a third SPDT switch control signal 5301 to toggle the third SPDT switch 530 to its first output end, and a fourth SPDT switch control signal 5401 to toggle the fourth SPDT switch 540 to its second input end. In this manner, the KVM switch system 500 can control the first host 106 via the SoC 104. When the KVM switch system 500 intends to toggle the SoC 104 to control the second host 108, the SoC 104 generates the first SPDT switch control signal 1101 to toggle the first SPDT switch 110 to its second output end, the third SPDT switch control signal 5301 to toggle the third SPDT switch 530 to its second output end, and the fifth SPDT switch control signal 5501 to toggle the fifth SPDT switch 550 to its second input end. In this manner, the KVM switch system 500 can control the second host 108 via the SoC 104.

In one embodiment, the first Single Pole Double Throw (SPDT) switch 110 in the KVM switch system 500 is coupled to the monitor 102 via a High Definition Multimedia Interface (HDMI), and to the keyboard and mouse 102 via a Universal Serial Bus (USB). In one embodiment, the first host 106 and second host 108 are personal computers.

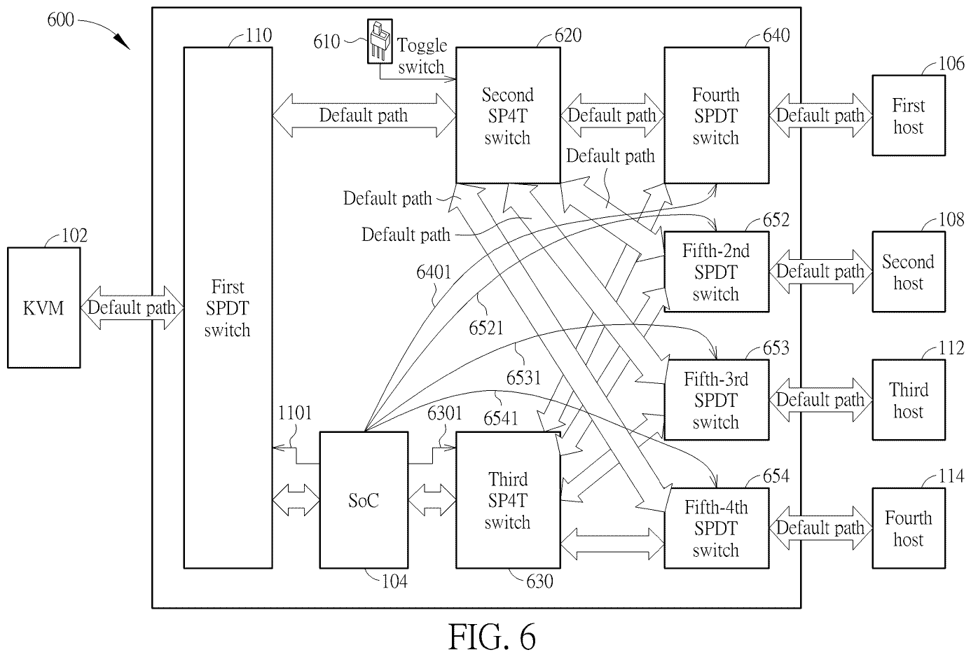

FIG. 6 is a block diagram illustrating a KVM switch system 600 according to another embodiment of the present invention. The KVM switch system 600 includes a first Single Pole Double Throw (SPDT) switch 110, a System on Chip (SoC) 104, a toggle switch 610, a second Single Pole Four Throw (SP4T) switch 620, a third SP4T switch 630, a fourth SPDT switch 640, a fifth-2nd SPDT switch 652, a fifth-3rd SPDT switch 653, and a fifth-4th SPDT switch 654. The first SPDT switch 110 includes an input end coupled to a keyboard, mouse, and monitor 102; a first output end; and a second output end. The SoC 104 includes a first end coupled to the second output end of the first SPDT switch 110, and a second end. The toggle switch 610 is coupled to the second SP4T switch 620 for manually switching the output path of the second SP4T switch 620 when in default mode. The second SP4T switch 620 includes an input end coupled to the first output end of the first SPDT switch 110, a first output end, a second output end, a third output end, and a fourth output end. The third SP4T switch 630 includes an input end coupled to the second end of the SoC 104, a first output end, a second output end, a third output end, and a fourth output end. The fourth SPDT switch 640 includes a first input end coupled to the first output end of the second SP4T switch 620, a second input end coupled to the first output end of the third SP4T switch 630, and an output end coupled to a first host 106. The fifth-2nd SPDT switch 652 includes a first input end coupled to the second output end of the second SP4T switch 620, a second input end coupled to the second output end of the third SP4T switch 630, and an output end coupled to a second host 108. The fifth-3rd SPDT switch 653 includes a first input end coupled to the third output end of the second SP4T switch 620, a second input end coupled to the third output end of the third SP4T switch 630, and an output end coupled to a third host 112. The fifth-4th SPDT switch 654 includes a first input end coupled to the fourth output end of the second SP4T switch 620, a second input end coupled to the fourth output end of the third SP4T switch 630, and an output end coupled to a fourth host 114.

When the System on Chip (SoC) 104 is undergoing firmware updates or fails to boot, the KVM switch system 600 automatically enters default mode. In default mode, the first Single Pole Double Throw (SPDT) switch 110 is preset to enable its first output end, the fourth SPDT switch 640 is preset to enable its first input end, the fifth-2nd SPDT switch 652 is preset to enable its first input end, the fifth-3rd SPDT switch 653 is preset to enable its first input end, and the fifth-4th SPDT switch 654 is preset to enable its first input end. The toggle switch 610 allows manual switching of the second Single Pole Four Throw (SP4T) switch 620 to its first, second, third, or fourth output end, thereby enabling the KVM switch system 600 to default to using the first host 106, second host 108, third host 112, or fourth host 114. The signal path in default mode for switching to the first host 106 is as follows: the keyboard, mouse, and monitor 102 transmit or receive signals through the first SPDT switch 110, then pass through the second SP4T switch 620, followed by the fourth SPDT switch 640—which is controlled by the toggle switch 610—and finally reach the first host 106. The signal path in default mode for switching to the second host 108 is as follows: the keyboard, mouse, and monitor 102 transmit or receive signals through the first SPDT switch 110, then pass through the second SP4T switch 620, followed by the fifth-2nd SPDT switch 652—which is controlled by the toggle switch 610—and finally reach the second host 108. The signal path in default mode for switching to the third host 112 is as follows: the keyboard, mouse, and monitor 102 transmit or receive signals through the first SPDT switch 110, then pass through the second SP4T switch 620, followed by the fifth-3rd SPDT switch 653—which is controlled by the toggle switch 610—and finally reach the third host 112. The signal path in default mode for switching to the fourth host 114 is as follows: the keyboard, mouse, and monitor 102 transmit or receive signals through the first SPDT switch 110, then pass through the second SP4T switch 620, followed by the fifth-4th SPDT switch 654—which is controlled by the toggle switch 610—and finally reach the fourth host 114.

When the KVM switch system 600 intends to toggle the System on Chip (SoC) 104 to control the first host 106, the SoC 104 generates a first SPDT switch control signal 1101 to toggle the first SPDT switch 110 to its second output end, a third Single Pole Four Throw (SP4T) switch control signal 6301 to toggle the third SP4T switch 630 to its first output end, and a fourth SPDT switch control signal 6401 to toggle the fourth SPDT switch 640 to its second input end. In this manner, the KVM switch system 600 can control the first host 106 via the SoC 104. When the KVM switch system 600 intends to switch the SoC 104 to control the second host 108, the SoC 104 generates the first SPDT switch control signal 1101 to toggle the first SPDT switch 110 to its second output end, the third SP4T switch control signal 6301 to toggle the third SP4T switch 630 to its second output end, and the fifth-2nd SPDT switch control signal 6521 to toggle the fifth-2nd SPDT switch 652 to its second input end. In this manner, the KVM switch system 600 can control the second host 108 via the SoC 104. When the KVM switch system 600 intends to toggle the SoC 104 to control the third host 112, the SoC 104 generates the first SPDT switch control signal 1101 to toggle the first SPDT switch 110 to its second output end, the third SP4T switch control signal 6301 to toggle the third SP4T switch 630 to its third output end, and the fifth-3rd SPDT switch control signal 6531 to toggle the fifth-3rd SPDT switch 653 to its second input end. In this manner, the KVM switch system 600 can control the third host 112 via the SoC 104. When the KVM switch system 600 intends to toggle the SoC 104 to control the fourth host 114, the SoC 104 generates the first SPDT switch control signal 1101 to toggle the first SPDT switch 110 to its second output end, the third SP4T switch control signal 6301 to toggle the third SP4T switch 630 to its fourth output end, and the fifth-4th SPDT switch control signal 6541 to toggle the fifth-4th SPDT switch 654 to its second input end. In this manner, the KVM switch system 600 can control the fourth host 114 via the SoC 104.

In one embodiment, the first Single Pole Double Throw (SPDT) switch 110 in the KVM switch system 600 is coupled to the monitor 102 via a High Definition Multimedia Interface (HDMI), and to the keyboard and mouse 102 via a Universal Serial Bus (USB). In one embodiment, the first host 106, second host 108, third host 112, and fourth host 114 are personal computers.

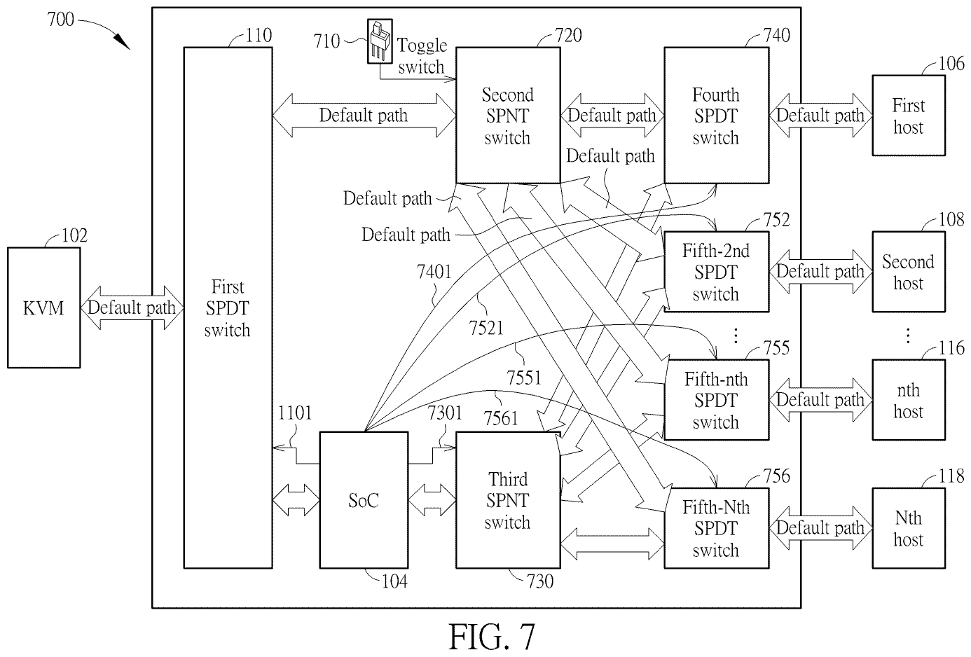

FIG. 7 is a block diagram illustrating a KVM switch system 700 according to another embodiment of the present invention. The KVM switch system 700 includes a first Single Pole Double Throw (SPDT) switch 110, a System on Chip (SoC) 104, a toggle switch 710, a second Single Pole N Throw (SPNT) switch 720, a third SPNT switch 730, a fourth SPDT switch 740, a fifth-2nd SPDT switch 752, a fifth-nth SPDT switch 755, and a fifth-Nth SPDT switch 756. The first SPDT switch 110 includes an input end coupled to a keyboard, mouse, and monitor 102; a first output end; and a second output end. The SoC 104 includes a first end coupled to the second output end of the first SPDT switch 110, and a second end. The toggle switch 710 is coupled to the second SPNT switch 720 for manually switching the output path of the second SPNT switch 720 when in default mode. The second SPNT switch 720 includes an input end coupled to the first output end of the first SPDT switch 110, a first output end, and an nth output end. The third SPNT switch 730 includes an input end coupled to the second end of the SoC 104, a first output end, and an nth output end. The fourth SPDT switch 740 includes a first input end coupled to the first output end of the second SPNT switch 720, a second input end coupled to the first output end of the third SPNT switch 730, and an output end coupled to a first host 106. The fifth-2nd SPDT switch 752 includes a first input end coupled to the second output end of the second SPNT switch 720, a second input end coupled to the second output end of the third SPNT switch 730, and an output end coupled to a second host 108. The fifth-nth SPDT switch 755 includes a first input end coupled to the nth output end of the second SPNT switch 720, a second input end coupled to the nth output end of the third SPNT switch 730, and an output end coupled to an nth host 116. The fifth-Nth SPDT switch 756 includes a first input end coupled to the Nth output end of the second SPNT switch 720, a second input end coupled to the Nth output end of the third SPNT switch 730, and an output end coupled to an Nth host 118.

When the System on Chip (SoC) 104 is undergoing firmware updates or fails to boot, the KVM switch system 700 automatically enters default mode. In default mode, the first Single Pole Double Throw (SPDT) switch 110 is preset to enable its first output end, the fourth SPDT switch 740 is preset to enable its first input end, the fifth-2nd SPDT switch 752 is preset to enable its first input end, the fifth-nth SPDT switch 755 is preset to enable its first input end, and the fifth-Nth SPDT switch 756 is preset to enable its first input end. The toggle switch 710 allows manual switching of the second Single Pole N Throw (SPNT) switch 720 to the first, second, nth, or Nth output end, thereby enabling the KVM switch system 700 to default to using the first host 106, second host 108, nth host 116, or Nth host 118. In one embodiment, N≥n>1, and both N and n are positive integers. The signal path in default mode for switching to the first host 106 is as follows: the keyboard, mouse, and monitor 102 transmit or receive signals through the first SPDT switch 110, then pass through the second SPNT switch 720, followed by the fourth SPDT switch 740—which is controlled by the toggle switch 710—and finally reach the first host 106. The signal path in default mode for switching to the nth host 116 is as follows: the keyboard, mouse, and monitor 102 transmit or receive signals through the first SPDT switch 110, then pass through the second SPNT switch 720, followed by the fifth-nth SPDT switch 755—which is controlled by the toggle switch 710—and finally reach the nth host 116.

When the KVM switch system 700 intends to toggle the System on Chip (SoC) 104 to control the first host 106, the SoC 104 generates a first SPDT switch control signal 1101 to toggle the first SPDT switch 110 to its second output end, a third Single Pole N Throw (SPNT) switch control signal 7301 to toggle the third SPNT switch 730 to its first output end, and a fourth SPDT switch control signal 7401 to toggle the fourth SPDT switch 740 to its second input end. In this manner, the KVM switch system 700 can control the first host 106 via the SoC 104. When the KVM switch system 700 intends to toggle the SoC 104 to control the nth host 116, the SoC 104 generates the first SPDT switch control signal 1101 to toggle the first SPDT switch 110 to its second output end, the third SPNT switch control signal 7301 to toggle the third SPNT switch 730 to its nth output end, and the fifth-nth SPDT switch control signal 7551 to toggle the fifth-nth SPDT switch 755 to its second input end. In this manner, the KVM switch system 700 can control the nth host 116 via the SoC 104.

In one embodiment, the first Single Pole Double Throw (SPDT) switch 110 in the KVM switch system 700 is coupled to the monitor 102 via a High Definition Multimedia Interface (HDMI), and to the keyboard and mouse 102 via a Universal Serial Bus (USB). In one embodiment, the first host 106, second host 108, nth host 116, and Nth host 118 are personal computers.

In Summary, in the Embodiments of the Present

invention, the default paths of the KVM switch systems 100, 200, 300, 400, 500, 600, and 700 allow the keyboard, mouse, and monitor 102 to control the host computers without passing through the System on Chip (SoC) 104. Therefore, even when the SoC 104 is undergoing firmware updates or fails to boot, the KVM switch systems 100, 200, 300, 400, 500, 600, and 700 can still operate via the default path to control the computers. The present invention achieves this functionality by incorporating various switches into the system, without requiring additional identical KVM switch hardware, thereby reducing hardware costs and improving usability.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A KVM (Keyboard, Video, Mouse) switch system, comprising:
a first single-pole double-throw (SPDT) switch, comprising:
an input end, coupled to a keyboard, a mouse, and a monitor;
a first output end; and
a second output end;
a system on chip (SoC), comprising:
a first end, coupled to the second output end of the first SPDT switch; and
a second end; and
a second double-pole double-throw (DPDT) switch, comprising:
a first input end, coupled to the first output end of the first SPDT switch;
a second input end, coupled to the second end of the SoC;
a first output end, coupled to a first host; and
a second output end, coupled to a second host;
wherein when the KVM switch system is in a default mode, the first SPDT switch is preset to enable its first output end, and the second DPDT switch is preset to enable its first input end and its first output end, setting the KVM switch system to default to using the first host.

2. The KVM switch system of claim 1, wherein when the SoC is to be switched to couple to the first host, the SoC generates a first SPDT switch control signal for the first SPDT switch to toggle to its second output end, and generates a second DPDT switch control signal for the second DPDT switch to toggle to its second input end and its first output end.

3. The KVM switch system of claim 1, wherein when the SoC is to be switched to couple to the second host, the SoC generates a first SPDT switch control signal for the first SPDT switch to toggle to its second output end, and generates a second DPDT switch control signal for the second DPDT switch to toggle to its second input end and its second output end.

4. The KVM switch system of claim 1, wherein the first SPDT switch is coupled to the monitor via a High Definition Multimedia Interface (HDMI), and coupled to the keyboard and mouse via a Universal Serial Bus (USB).

5. The KVM switch system of claim 1, wherein the first host and the second host are personal computers.

6. The KVM switch system of claim 1, wherein when the SoC is updating firmware or fails to boot, the KVM switch system enters the default mode.

7. A KVM (Keyboard, Video, Mouse) switch system, comprising:
a first single-pole double-throw (SPDT) switch, comprising:
an input end, coupled to a keyboard, a mouse, and a monitor;
a first output end; and
a second output end;
a system on chip (SoC), comprising:
a first end, coupled to the second output end of the first SPDT switch; and
a second end;
a second single-pole N-throw (SPNT) switch, comprising:
an input end coupled to the second end of the SoC;
a first output end; and
an nth output end, coupled to an nth host; and
a third SPDT switch, comprising:
a first input end, coupled to the first output end of the first SPDT switch;
a second input end, coupled to the first output end of the second SPNT switch; and
an output end, coupled to a first host;
wherein when the KVM switch system is in a default mode, the first SPDT switch is preset to enable its first output end, and the third SPDT switch is preset to enable its first input end, setting the KVM switch system to default to using the first host, and N≥n>1.

8. The KVM switch system of claim 7, wherein when the SoC is to be switched to couple to the first host, the SoC generates a first SPDT switch control signal for the first SPDT switch to toggle to its second output end, generates a second SPNT switch control signal for the second SPNT switch to toggle to its first output end, and generates a third SPDT switch control signal for the third SPDT switch to toggle to its second input end.

9. The KVM switch system of claim 7, wherein when the SoC is to be switched to couple to the nth host, the SoC generates a first SPDT switch control signal for the first SPDT switch to toggle to its second output end, and generates a second SPNT switch control signal for the second SPNT switch to toggle to its nth output end.

10. The KVM switch system of claim 7, wherein the first SPDT switch is coupled to the monitor via a High Definition Multimedia Interface (HDMI), and coupled to the keyboard and mouse via a Universal Serial Bus (USB).

11. The KVM switch system of claim 7, wherein the first host and the nth host are personal computers.

12. The KVM switch system of claim 7, wherein when the SoC is updating firmware or fails to boot, the KVM switch system enters the default mode.

13. A KVM (Keyboard, Video, Mouse) switch system, comprising:
a first single-pole double-throw (SPDT) switch, comprising:
an input end, coupled to a keyboard, a mouse, and a monitor;
a first output end; and
a second output end;
a system on chip (SoC), comprising:
a first end, coupled to the second output end of the first SPDT switch; and
a second end;
a second single-pole N-throw (SPNT) switch, comprising:
an input end, coupled to the first output end of the first SPDT switch;
a first output end; and
an nth output end;
a third SPNT switch, comprising:
an input end, coupled to the second end of the SoC;
a first output end; and
an nth output end;
a fourth SPDT switch, comprising:
a first input end, coupled to the first output end of the second SPNT switch;
a second input end, coupled to the first output end of the third SPNT switch; and
an output end, coupled to a first host;
a fifth-nth SPDT switch, comprising:
a first input end, coupled to the nth output end of the second SPNT switch;
a second input end, coupled to the nth output end of the third SPNT switch; and
an output end, coupled to an nth host;
wherein when the KVM switch system is in a default mode, the first SPDT switch is preset to enable its first output end, the fourth SPDT switch is preset to enable its first input end, and the fifth-nth SPDT switch is preset to enable its first input end, setting the KVM switch system to default to using the first host or the nth host, and N≥n>1.

14. The KVM switch system of claim 13, further comprising a toggle switch, configured to toggle the second SPNT switch to its first output end or its nth output end, setting a default path of the KVM switch system to the first host or the nth host.

15. The KVM switch system of claim 13, wherein when the SoC is to be switched to couple to the first host, the SoC generates a first SPDT switch control signal for the first SPDT switch to toggle to its second output end, generates a third SPNT switch control signal for the third SPNT switch to toggle to its first output end, and generates a fourth SPDT switch control signal for the fourth SPDT switch to toggle to its second input end.

16. The KVM switch system of claim 13, wherein when the SoC is to be switched to couple to the nth host, the SoC generates a first SPDT switch control signal for the first SPDT switch to toggle to its second output end, generates a third SPNT switch control signal for the third SPNT switch to toggle to the nth output end, and generates a fifth-nth SPDT switch control signal for the fifth-nth SPDT switch to toggle to its second input end.

17. The KVM switch system of claim 13, wherein the first SPDT switch is coupled to the monitor via a High Definition Multimedia Interface (HDMI), and coupled to the keyboard and mouse via a Universal Serial Bus (USB).

18. The KVM switch system of claim 13, wherein the first host and the nth host are personal computers.

19. The KVM switch system of claim 13, wherein when the SoC is updating firmware or fails to boot, the KVM switch system enters the default mode.
